(19) United States
(12) Patent Application Publication
(10) Pub. No.: US 2023/0118999 A1
(43) Pub. Date: Apr. 20, 2023

(54) PLATE, SOLE, SHOE, AND METHOD OF MANUFACTURING PLATE

(71) Applicants: ASICS CORPORATION, Kobe-shi (JP); TORAY INDUSTRIES, INC., Tokyo (JP)

(72) Inventors: Kenta TATENO, Kobe-shi (JP); Yoshikazu MITSUHATA, Kobe-shi (JP); Shin HIRATA, Nagoya-shi (JP); Ryo SUZUKI, Tokyo (JP)

(73) Assignees: ASICS CORPORATION, Kobe-shi (JP); TORAY INDUSTRIES, INC., Tokyo (JP)

(21) Appl. No.: 18/046,109

(22) Filed: Oct. 12, 2022

(30) Foreign Application Priority Data
Oct. 15, 2021 (JP) 2021-169235

(51) Int. Cl. A43B 13/02; B29D 35/00; B29D 35/12; A43B 7/1405; A43B 13/18

(52) U.S. Cl. CPC A43B 13/026; B29D 35/0036; B29D 35/122; A43B 7/141; A43B 13/187

(57) ABSTRACT

A plate is used for a sole that forms a part of a shoe. The plate includes a reinforcement portion composed of a composite material containing a synthetic resin and a plurality of fibers. The plurality of fibers in the reinforcement portion each have a weight average fiber length not shorter than 0.4 mm and not longer than 7.0 mm and have such an orientation property that orientations thereof are aligned in a foot length direction.

This nonprovisional application is based on Japanese Patent Application No. 2021-169235 filed with the Japan Patent Office on Oct. 15, 2021, the entire contents of which are hereby incorporated by reference.

### BACKGROUND OF THE INVENTION

### Field of the Invention

This disclosure relates to a plate, a sole, a shoe, and a method of manufacturing a plate.

### Description of the Background Art

With reduction in weight of a material for forming a midsole in a sole in recent years, a sole with a midsole having a larger thickness for enhancing shock-absorbing performance has increased. With a larger thickness of the sole, on the other hand, a distance from the ground to the center of gravity of a body increases, and a plate may be provided in the midsole for enhancing stability.

For example, Japanese National Patent Publication No. 2018-534028 discloses a sole structure including an outsole, a cushioning member provided on the outsole, a midsole provided on the cushioning member, and a plate arranged between the cushioning member and the midsole. The plate is uniform in flexural rigidity in its entirety.

### SUMMARY OF THE INVENTION

The plate described in Japanese National Patent Publication No. 2018-534028 is very high in flexural rigidity because it is formed of a plurality of fiber layers. Therefore, in natural running motions in which a foot contacts the ground from an outer side in a foot width direction, loads imposed on a foot portion may be high depending on a way of contact with the ground. This is more noticeable as the plate is arranged lower in the sole.

An object of the present disclosure is to provide a plate, a sole, a shoe, and a method of manufacturing a plate that can achieve both of mitigation of shock at the time of contact with the ground and improvement in stability in a foot length direction.

A plate according to one aspect of this disclosure is a plate used for a sole that forms a part of a shoe. The plate includes a reinforcement portion composed of a composite material containing a synthetic resin and a plurality of fibers. The plurality of fibers in the reinforcement portion each have a weight average fiber length not shorter than 0.4 mm and not longer than 7.0 mm and have such an orientation property that orientations are aligned in a foot length direction.

A plate according to another aspect of this disclosure is a plate used for a sole that forms a part of a shoe. The plate includes a reinforcement portion composed of a composite material containing a synthetic resin and a plurality of fibers. Flexural rigidity of the reinforcement portion in a foot length direction of the shoe is at least two times as high as flexural rigidity of the reinforcement portion in a foot width direction of the shoe. The plurality of fibers in the reinforcement portion each have a weight average fiber length not shorter than 0.4 mm and not longer than 7.0 mm.

A sole according to one aspect of this disclosure includes the plate and a midsole that holds the plate.

A shoe according to one aspect of this disclosure includes the sole and an upper connected to the sole and located above the sole.

A method of manufacturing a plate according to one aspect of this disclosure is a method of manufacturing a plate used for a sole that forms a part of a shoe. The method includes a preparation step of preparing a mold provided with a space in a shape conforming to the plate and an injection step of forming, by injecting a composite material containing a synthetic resin and a plurality of fibers from a toe side toward a heel side in the mold or from the heel side toward the toe side in the mold, a reinforcement portion having such an orientation property that orientations of the plurality of fibers are aligned in a foot length direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view schematically showing a shoe in one embodiment of the present disclosure.

FIG. 2 is a plan view showing relation between the sole and a bone of a foot of a wearer of the shoe.

FIG. 3 is a perspective view of a plate.

FIG. 4 is a cross-sectional view schematically showing a mold used for manufacturing the plate.

FIGS. 5 to 10 are each a plan view showing a modification of the plate.

FIG. 11 shows a table showing results in Example and Comparative Example.

### DESCRIPTION OF THE PREFERRED EMBODIMENTS

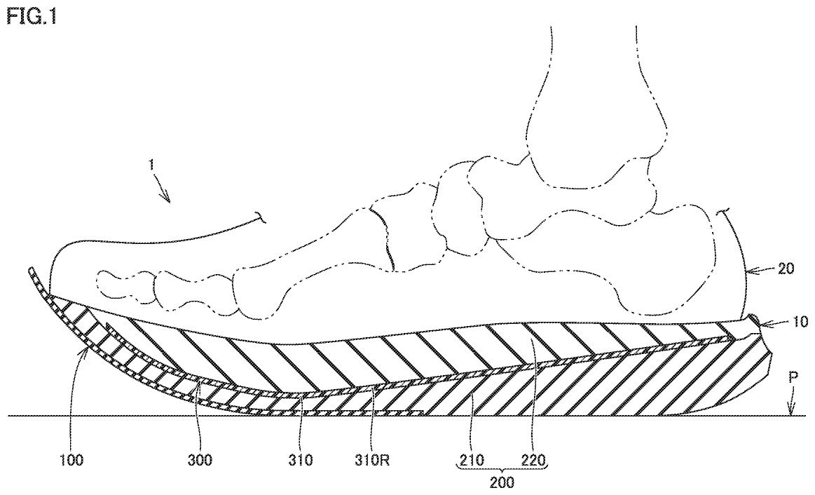

An embodiment of this disclosure will be described with reference to the drawings. The same or corresponding members in the drawings referred to below have the same reference characters allotted. In the description below, such terms as a foot length direction, a foot width direction, front, and rear are used. The terms indicating directions refer to directions viewed from a point of view of a wearer who wears a shoe 1 placed on a flat plane P (see FIG. 1) such as the ground. For example, the front refers to a toe side and the rear refers to a heel side. In addition, an inner side refers to an inner side of a foot (a first toe side of a foot) in the foot width direction and an outer side refers to an outer side of the foot in the foot width direction. The foot width direction means a direction orthogonal to the foot length direction.

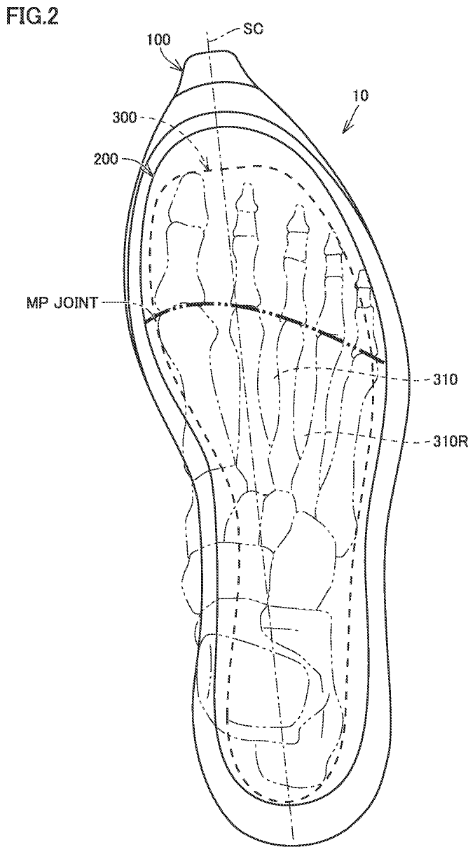

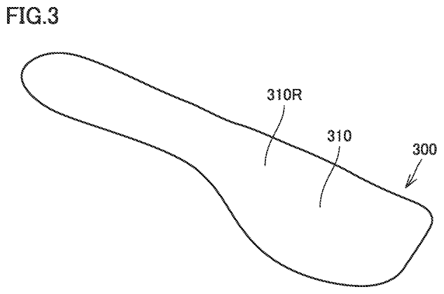

FIG. 1 is a cross-sectional view schematically showing a shoe in one embodiment of the present disclosure. FIG. 2 is a plan view showing relation between the sole and a bone of a foot of a wearer of the shoe. FIG. 3 is a perspective view of a plate.

FIG. 2 shows a sole 10 including a plate 300 for a right foot and FIG. 3 shows the plate 300 for a left foot. The plates 300 are in a shape symmetrical to each other. This is also applicable to a sole 10 and the shoe 1 including the plate 300. The shoe 1 in the present embodiment is applicable, for example, as a sports shoe for such sports as running and a walking shoe, and the shoe 1 may be used in any application.

As shown in FIG. 1, the shoe 1 includes the sole 10 and an upper 20.

The upper 20 is connected to the sole 10, and defines, together with the sole 10, a space where a foot of a wearer is accommodated.

As shown in FIG. 1, the sole 10 includes an outer sole 100, a midsole 200, and the plate 300.

The outer sole 100 forms a grounding portion. The outer sole 100 is composed of a resin, rubber, or the like.

The midsole 200 is provided on the outer sole 100. The midsole 200 is formed of a foamed material or the like made of a resin. The upper 20 is arranged on the midsole 200. In other words, the midsole 200 is provided between the upper 20 and the outer sole 100.

As shown in FIG. 1, the midsole 200 includes a lower midsole 210 and an upper midsole 220.

The lower midsole 210 is provided on the outer sole 100. At least a part of a lower surface of the lower midsole 210 is covered with the outer sole 100. The lower surface of the lower midsole 210 may be covered with the outer sole 100 only partially or entirely.

The upper midsole 220 is connected on the lower midsole 210. The upper midsole 220 may be higher in rigidity than the lower midsole 210 or may be equal in rigidity to the lower midsole 210.

The plate 300 forms a part of the sole 10. The plate 300 is provided in the midsole 200. As shown in FIG. 1, in the present embodiment, the plate 300 is arranged within the midsole 200. Specifically, the plate 300 is arranged between the lower midsole 210 and the upper midsole 220. The plate 300 is bonded to at least one of the lower midsole 210 and the upper midsole 220. The midsole 200 includes an accommodation portion that defines a space where the plate 300 is accommodated. The accommodation portion is in a shape conforming to the shape of the plate 300.

As shown in FIGS. 1 and 2, the plate 300 is in a shape extending from a position superimposed in a direction of thickness of the sole 10, on a front end of a foot of a wearer of the shoe 1 to a position superimposed in the direction of thickness, on a rear end of the foot of the wearer.

As shown in FIGS. 1 to 3, the plate 300 includes a reinforcement portion 310. In the present embodiment, the entire plate 300 is formed from the reinforcement portion 310. The reinforcement portion 310, however, may be formed only in a part of the plate 300. The reinforcement portion 310 is composed of a composite material containing a synthetic resin and a plurality of fibers. Examples of fibers contained in the composite material include carbon fibers, glass fibers, aramid fibers, dyneema® fibers, ZYLON® fibers, and boron fibers. In the present embodiment, carbon fibers are employed as the fibers. The reinforcement portion 310 is preferably formed by injection molding. The reinforcement portion 310 has a specific gravity preferably not larger than 1.15 and more preferably not larger than 1.13. The specific gravity is preferably not smaller than 1.05.

The plurality of fibers in the reinforcement portion 310 each have a weight average fiber length not shorter than 0.4 mm and have such an orientation property that orientations thereof are aligned in the foot length direction. These fibers have a weight average fiber length more preferably not shorter than 0.4 mm and not longer than 7.0 mm. When fibers in which an angle formed between a longitudinal direction thereof and the foot length direction is not larger than forty-five degrees occupy at least 50% of the total number of fibers per unit volume, such fibers are defined herein as “having the orientation property.”

The foot length direction is a direction in parallel to a shoe center SC (see FIG. 2). The shoe center SC is not limited to a centerline of the shoe 1 but may be a line corresponding to a straight line that connects the center of a heel hone of a standard wearer of the shoe 1 to a position between the first toe and the second toe.

The length of each fiber included in the reinforcement portion 310 can be measured as below. Specifically, for example, a sample piece haying a 2 cm-square size is taken from the reinforcement portion 310. Then, only a plurality of fibers are extracted by burning or dissolving only a synthetic resin component contained in the sample piece. Those fibers are measured with an optical microscope or the like. This measurement is preferably conducted, for example, for approximately 400 to 1000 fibers.

The reinforcement portion 310 is higher in orientation property in a middle potion (a region where a dimension in the foot width direction decreases toward the rear in the foot length direction) than in a front end portion and a rear end portion in the foot length direction. The reinforcement portion 310 includes an orientation region 310R (see FIGS. 1 to 3) that gradually becomes higher in orientation property from a part located closest to the plane P when the shoe 1 is placed on the plane P toward the rear in the foot length direction.

The reinforcement portion 310 is higher in flexural rigidity than the midsole 200. Flexural rigidity of the reinforcement portion 310 in the foot length direction is at least two times as high as flexural rigidity of the reinforcement portion 310 in the foot width direction. Flexural rigidity of the reinforcement portion 310 in the foot length direction is more preferably at least 2.5 times as high as flexural rigidity of the reinforcement portion 310 in the foot width direction. For example, flexural rigidity of the reinforcement portion 310 in the foot length direction is set to be not lower than 10 GPa and not higher than 17 GPa. Flexural rigidity of the reinforcement portion 310 in the foot width direction is set to be not lower than 5 GPa and not higher than 10 GPa.

Flexural rigidity of the reinforcement portion 310 in the foot length direction means rigidity at the time when the reinforcement portion 310 is bent with respect to a straight line in parallel to the foot width direction. Flexural rigidity of the reinforcement portion 310 in this foot length direction is measured in a three-point bending test. Specifically, a sample piece is cut from the reinforcement portion 310, and while two points in the sample piece distant from each other in the foot length direction are supported, a point intermediate between the two points is pressed by an indenter in the direction of thickness of the sample piece to measure flexural rigidity. A sample piece is cut, for example, into such a size that a. support span is set to 24 mm and a dimension in a direction orthogonal to a direction of connection of supported points is set to 10 mm. A rate of pressing by the indenter is set to 2 mm/min.

Flexural rigidity of the reinforcement portion 310 in the tot width direction means rigidity at the time when the reinforcement portion 310 is bent with respect to a straight line in parallel to the foot length direction. A method of measuring this flexural rigidity is similar to the method of measuring flexural rigidity of the reinforcement portion 310 in the foot length direction.

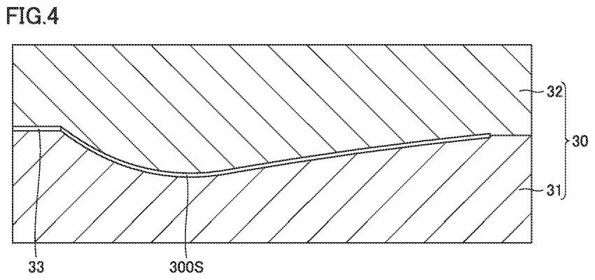

A method of manufacturing a plate 300 will now be described with reference to FIG. 4. This manufacturing method includes a preparation step and an injection step.

The preparation step is a step of preparing a mold 30 provided with a space 300S in a shape conforming to the plate 300. The mold 30 includes a lower mold 31 and an upper mold 32 connectable to and separable from the lower mold 31. The space 300S is provided at a boundary between the lower mold 31 and the upper mold 32. The mold 30 includes a gate 33 that communicates with the space 300S. The gate 33 communicates with an end portion on the toe side of the space 300S. The gate 33 may communicate with an end portion on the heel side of the space 300S.

The injection step is a step of forming, by injecting a composite material containing a synthetic resin and a plurality of fibers through the gate 33 from the toe side toward the heel side in the mold 30, the reinforcement portion 310 having such an orientation property that orientations of the plurality of fibers are aligned in the foot length direction. When the gate 33 communicates with the end portion on the heel side of the space 300S, in the injection step, the composite material is injected from the heel side toward the toe side in the mold 30.

As described above, in the plate 300 in the present embodiment, each fiber in the reinforcement portion 310 has the weight average fiber length not shorter than 0.4 mm and not longer than 7.0 mm and has such an orientation property that the orientation thereof is aligned in the foot length direction. Therefore, flexural rigidity of the reinforcement portion 310 in the foot length direction is higher than flexural rigidity of the reinforcement portion 310 in the foot width direction. Specifically, flexural rigidity of the reinforcement portion 310 in the foot length direction is at least two times as high as flexural rigidity of the reinforcement portion 310 in the foot width direction. In other words, flexural rigidity of the reinforcement portion 310 in the foot width direction is lower than flexural rigidity of the reinforcement portion 310 in the foot length direction. Therefore, in natural running motions in which the foot contacts the ground from the outer side in the foot width direction, loads imposed on the foot portion at the time of contact with the ground are mitigated. Since flexural rigidity of the reinforcement portion 310 in the foot length direction is high, excessive deformation of the sole 10 in particular at the time of take-off is suppressed and hence stability in the foot length direction is improved.

Since the plate 300 including the reinforcement portion 310 in the present embodiment is formed by injection molding, excessive flexural rigidity can be avoided as in the plate described in Patent Literature 1 (Japanese National Patent Publication No. 2018-534028), that is, the structure in which a plurality of prepreg fiber sheets are layered. In addition, since the fibers in the reinforcement portion 310 have such an orientation property that orientations thereof are aligned in the foot length direction, flexural rigidity in the foot length direction necessary for providing efficiency in running or stability is secured.

A modification of the embodiment will be described below.

### FIRST MODIFICATION

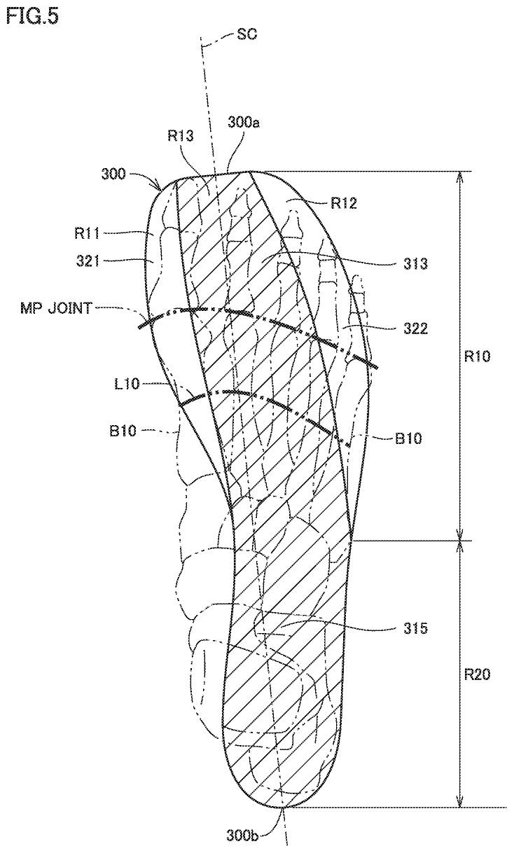

As shown in FIG. 5, the plate 300 may include a front reinforcement region R10 and a rear reinforcement region R20.

The front reinforcement region R10 extends from a front end portion 300a located at a front end of the plate 300 in the foot length direction toward a rear end portion 300b located at a rear end of the plate 300 in the foot length direction. More specifically, the front reinforcement region R10 extends from the front end portion 300a to a part superimposed in the direction of thickness of the sole 10, on a line L10 that connects central portions of metatarsal bones B10 of the wearer of the shoe 1 to each other. In an example shown in FIG. 5, the front reinforcement region R10 is formed in a range from the front end portion 300a of the plate 300 to a part closer to the rear end portion 300b than the line L10. In the example shown in FIG. 5, the front reinforcement region R10 is a region located in a range approximately from 0% to 60% of the entire length of the plate 300 from the front end portion 300a toward the rear end portion 300b.

The front reinforcement region R10 includes an inner foot region R11, an outer foot region R12, and a middle region R13.

The inner foot region R11 is formed on an inner side in the foot width direction. The inner foot region R11 is formed in a range superimposed on the metatarsal bone B10 of the first toe in the direction of thickness.

The outer foot region R12 is formed on an outer side in the foot width direction. The outer foot region R12 is formed in a range superimposed on the metatarsal bone B10 of a fifth toe in the direction of thickness.

The middle region R13 is formed between the inner foot region R11 and the outer foot region R12. The middle region R13 is formed in a range superimposed on the metatarsal bone B10 of the second toe and the metatarsal bone B10 of the third toe in the direction of thickness.

The rear reinforcement region R20 extends from a rear end portion of the front reinforcement region R10 to the rear end portion 300b of the plate 300.

The reinforcement portion 310 includes a middle reinforcement portion 313 provided in the middle region R13 and a rear reinforcement portion 315 provided in the rear reinforcement region R20. The middle reinforcement portion 313 and the rear reinforcement portion 315 are contiguous in the foot length direction. The rear reinforcement portion 315 is provided in the entire region in the foot width direction. FIG. 5 shows the middle reinforcement portion 313 and the rear reinforcement portion 315 with hatching.

The plate 300 may further include an inner foot support portion 321 and an outer foot support portion 322.

The inner foot support portion 321 is provided in the inner foot region R11. Flexural rigidity of the inner foot support portion 321 in the foot width direction is lower than flexural rigidity of the middle reinforcement portion 313 in the foot width direction.

The outer foot support portion 322 is provided in the outer foot region R12 Flexural rigidity of the outer foot support portion 322 in the foot width direction is lower than flexural rigidity of the middle reinforcement portion 313 in the foot width direction.

In this aspect, a degree of freedom in selection of a material for the inner foot support portion 321 and the outer foot support portion 322 is enhanced, for example, in such a manner as forming the inner foot support portion 321 and the outer foot support portion 322 of a material different from a material for the reinforcement portion 310.

In a first modification, the inner foot region R11 where the inner foot support portion 321 is provided may be formed from the reinforcement portion 310.

### SECOND MODIFICATION

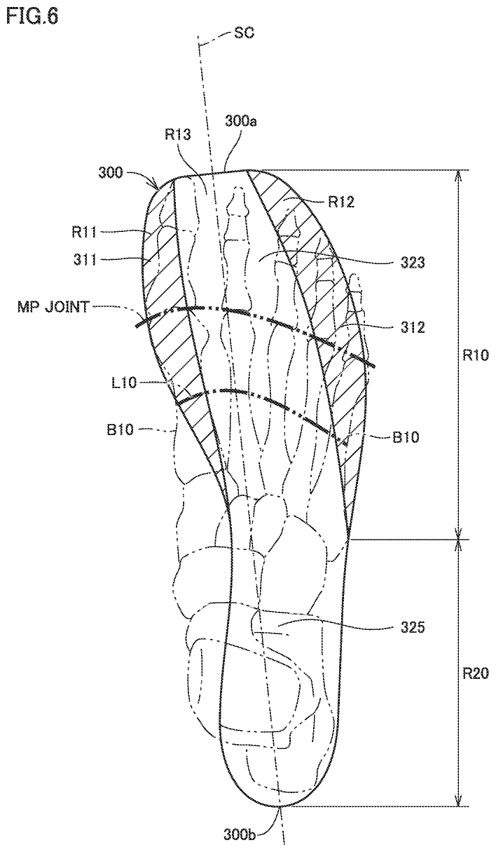

As shown in FIG. 6, the reinforcement portion 310 may include an inner foot reinforcement portion 311 provided in the inner foot region R11 and an outer foot reinforcement portion 312 provided in the outer foot region R12. The inner foot region R11 and the outer foot region R12 are the same in shape as in the first modification. FIG. 6 shows the inner foot reinforcement portion 311 and the outer foot reinforcement portion 312 with hatching.

The plate 300 may further include a middle support portion 323 provided in the middle, region R13 and a rear support portion 325 provided in the rear reinforcement region R20. The middle support portion 323 and the rear support portion 325 are contiguous in the foot length direction. The rear support portion 325 is provided in the entire region in the foot width direction.

Flexural rigidity of the inner foot reinforcement portion 311 in the foot width direction is lower than flexural rigidity of the middle support portion 323 in the foot width direction. Flexural rigidity of the outer foot reinforcement portion 312 in the foot width direction is lower than flexural rigidity of the middle support portion 323 in the foot width direction.

In a second modification, the inner foot region R11 where the inner foot reinforcement portion 311 is provided may be composed of a material the same as a material for the middle support portion 323.

### THIRD MODIFICATION

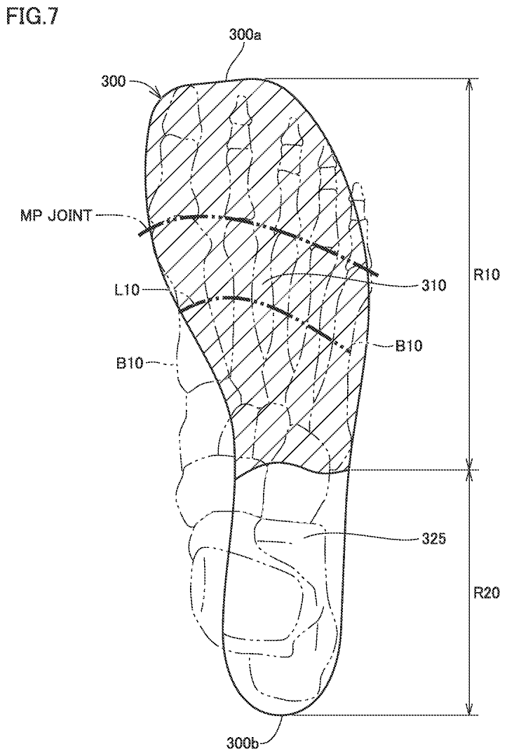

As shown in FIG. 7, the plate 300 may include the front reinforcement region R10 and the rear reinforcement region R20. In this example, the front reinforcement region R10 is a region located in a range approximately from 0% to 65% of the entire length of the plate 300 from the front end portion 300a toward the rear end portion 300b. In an example shown in FIG. 7, the reinforcement portion 310 is provided in the entire front reinforcement region R10. FIG. 7 shows the reinforcement portion 310 with hatching.

The plate 300 may further include the rear support portion 325 provided in the rear reinforcement region R20. The rear support portion 325 may be lower or higher in flexural rigidity than the reinforcement portion 310.

This plate 300 is formed by injecting the composite material containing the synthetic resin and the plurality of fibers from the end portion on the toe side into the space 300S in the mold 30 and injecting a material different from the composite material (a material composed only of the synthetic resin or the like) from the end portion on the heel side into the space 300S.

In this aspect, since the reinforcement portion 310 is arranged in a range that extends across an MP joint of the foot of the wearer in the foot length direction, excessive deformation of the sole 10 in particular at the time of take-off is suppressed.

### FOURTH MODIFICATION

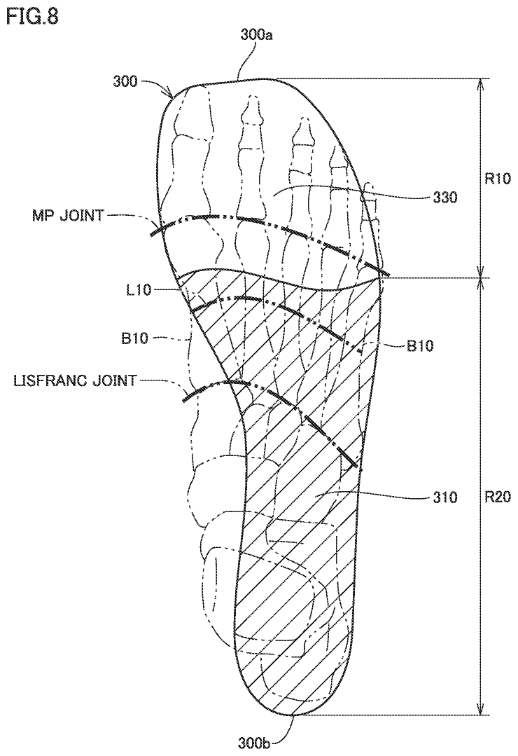

As shown in FIG. 8, the plate 300 may include the front reinforcement region R10 and the rear reinforcement region R20. The rear reinforcement region R20 extends from the rear end portion 300b of the plate 300 to a part superimposed in the direction of thickness of the sole 10, on the line L10 that connects the central portions of the metatarsal bones B10 of the wearer of the shoe 1 to each other. In an example shown in FIG. 8, the rear reinforcement region R20 is formed in a range from the rear end portion 300b of the plate 300 to a part closer to the front end portion 300a of the plate 300 than the line L10. In this example, the rear reinforcement region R20 is a region located in a range approximately from 0% to 70% of the entire length of the plate 300 from the rear end portion 300b toward the front end portion 300a. The reinforcement portion 310 is provided in the entire rear reinforcement region R20. FIG. 8 shows the reinforcement portion 310 with hatching.

The plate 300 may further include a front support portion 330 provided in the front reinforcement region R10. The front support portion 330 may be lower or higher in flexural rigidity than the reinforcement portion 310.

This plate 300 is formed by injecting the composite material containing the synthetic resin and the plurality of fibers from the end portion on the heel side into the space 300S in the mold 30 and injecting a material different from the composite material (a material composed only of the synthetic resin or the like) from the end portion on the toe side into the space 300S.

In this aspect, since the reinforcement portion 310 is arranged in a range that extends across a Lisfranc joint of the foot of the wearer in the foot length direction, excessive deformation of the sole 10 in particular at the time of take-off is suppressed.

### FIFTH MODIFICATION

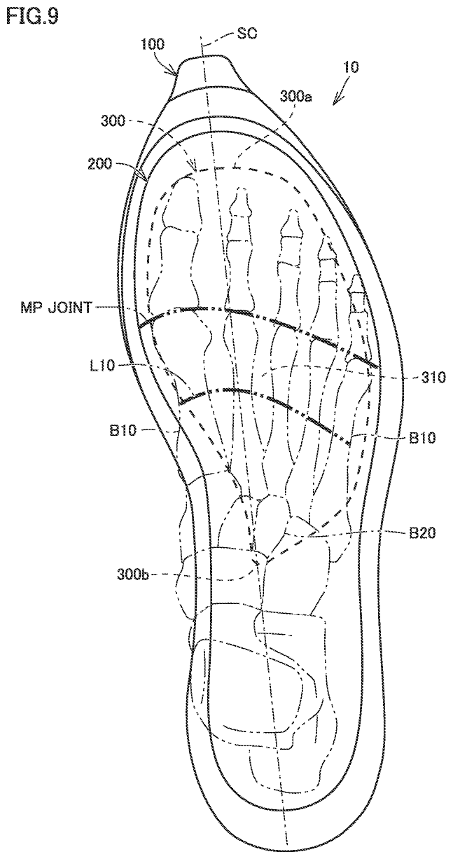

As shown in FIG. 9, the rear end portion 300b of the plate 300 may be formed at a position superimposed in the direction of thickness, on a third cuneiform bone (a lateral cuneiform bone) of the foot of the wearer of the shoe 1 or at a position slightly in the rear of that position in the foot length direction. In this example as well, the entire plate 300 may be formed from the reinforcement portion 310.

### SIXTH EMBODIMENT

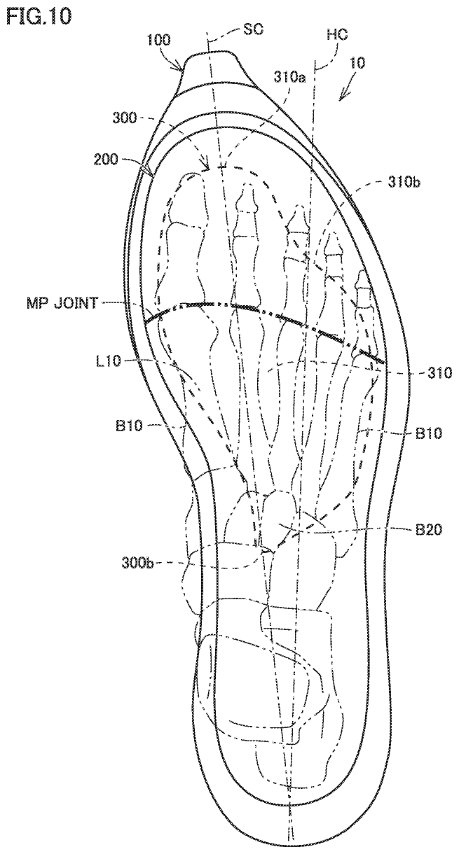

As shown in FIG. 10, the rear end portion 300b of the plate 300 may be similar to that in the fifth modification and the plate 300 may have an edge on the front end side formed from a front edge portion 310a and a recessed edge portion 310b.

The front edge portion 310a is formed at a position superimposed on a first distal phalanx and a second distal phalanx of the wearer in the direction of thickness or at a position in front of those positions in the foot length direction. The front edge portion 310a is in a shape convexly curved toward the front in the foot length direction. More specifically, the front edge portion 310a is in a shape convexly curved toward the front along the shoe center SC.

The recessed edge portion 310b is in a shape that extends from an outer end of the front edge portion 310a in the foot width direction rearward in the foot length direction, toward the outer side in a direction of width, and is curved convexly inward in the foot width direction. More specifically, the recessed edge portion 310b is in a shape intersecting with a heel center HC of the wearer and curved convexly inward in the foot width direction. The heel center HC means a straight line that connects the center of a heel bone of the standard wearer of the shoe 1 and a position between the third toe and the fourth toe to each other. The recessed edge portion 310b is larger in radius of curvature than the front edge portion 310a.

In this example as well, the entire plate 300 may be formed from the reinforcement portion 310.

### EXAMPLE

An Example of the embodiment together with a Comparative Example will now be described.

### (1) Measurement of Weight Average Fiber Length

A solvent in which a synthetic resin contained in a test piece cut from a molded product was dissolvable was selected as appropriate. The test piece was placed in the selected solvent and subjected to heating treatment as appropriate to prepare the solvent in which fibers and the synthetic resin were separate from each other. Thereafter, the solvent was cast in filter paper. The fibers dispersed in the filter paper were obtained by drying the solvent, and the fibers were observed with an optical microscope (magnification from 50× to 200×) as described previously. A fiber length of randomly selected one thousand fibers was measured to calculate the weight average fiber length (Lw) in accordance with an expression below.

Average fiber length=Σ(Mi²×Ni)/Σ(Mi×Ni)

Mi: fiber length (mm)

Ni: the number of fibers having the fiber length Mi

### (2) Measurement of Flexural Rigidity of Molded Product

From a square-plate test piece having a size of 80 mm×80 mm×2 mm thick obtained in each of Example and Comparative Example, a strip test piece having a size of 80 mm×10 mm×2 mm thick was cut along each of a direction of flow of a resin (an MD direction below) in injection molding and a direction at a right angle (a TD direction below) with respect to the direction of flow of the resin in injection molding. Flexural rigidity of the obtained strip test piece was measured with the use of a three-point bending test jig (a radius of an indenter being 5 mm) under such a test condition as a support span of 32 mm and a test speed of 2 mm/min. “Instron”® 5566 Universal Testing Machine (manufactured by Instron) was employed as a test machine.

### (3) Measurement of Specific Gravity of Molded Product

From a square-plate test piece having a size of 80 mm×80 mm×2 mm thick obtained in each of Example and Comparative Example, a strip test piece having a size of 80 mm×10 mm×2 mm thick was cut. The specific gravity of the obtained test piece having the size of 80 mm×10 mm×2 mm thick was measured by an immersion method. Distilled water was employed as a solution and an average value of five test pieces was calculated.

### EXAMPLE

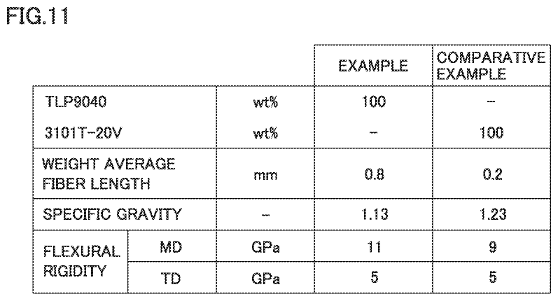

By injection molding Torayca™ long-fiber pellet “TLP9040” with the use of an injection molding machine SE75DUZ-C250 manufactured by Sumitomo Heavy Industries, Ltd. under such conditions as a time period of injection of two seconds, a back pressure of 10 MPa, a pressure retention time of ten seconds, a cylinder temperature of 230° C., and a mold temperature of 60° C., a test piece having a size of 80 mm×80 mm×2 mm thick was made as a molded product. The cylinder temperature refers to a temperature of a portion of the injection molding machine for heating and melting a material for molding, and the mold temperature refers to a temperature of the mold in which a resin is injected for molding into a prescribed shape. The obtained test piece was rested in a constant temperature and humidity chamber adjusted to a temperature of 23° C. and RH of 50% for twenty-four hours and thereafter subjected to characteristic evaluation. Table 1 shown in FIG. 11 summarizes results of evaluation with the method described previously.

### COMPARATIVE EXAMPLE

By injection molding Torayca™ short-fiber pellet “3101T-20V” with the use of the injection molding machine SE75DUZ-C250 manufactured by Sumitomo Heavy Industries, Ltd. under such conditions as a time period of injection of two seconds, a back pressure of 10 MPa, a pressure retention time of ten seconds, a cylinder temperature of 270° C., and a mold temperature of 60° C., a test piece having a size of 80 mm×80 mm×2 mm thick was made as a molded product. The cylinder temperature refers to a temperature of a portion of the injection molding machine for heating and melting a material for molding, and the mold temperature refers to a temperature of the mold in which a material for molding is injected for molding into a prescribed shape. The obtained test piece was rested in a constant temperature and humidity chamber adjusted to a temperature of 23° C. and RH of 50% for twenty-four hours and thereafter evaluated with the method described previously. Table 1 shown in FIG. 11 shows results of evaluation.

It should be understood that the embodiment and the example disclosed herein are illustrative and non-restrictive in every respect. The scope of the present invention is defined by the terms of the claims rather than the description of the embodiment and the example above and is intended to include any modifications within the scope and meaning equivalent to the terms of the claims.

### ASPECTS

Illustrative embodiments described above are understood by a person skilled in the art as specific examples of aspects below.

A plate according to one aspect of the embodiment is a plate used for a sole that forms a part of a shoe. The plate includes a reinforcement portion composed of a composite material containing a synthetic resin and a plurality of fibers. The plurality of fibers in the reinforcement portion each have a weight average fiber length not shorter than 0.4 mm and not longer than 7.0 mm and have such an orientation property that orientations are aligned in a foot length direction.

In this plate, the fibers in the reinforcement portion each have the weight average fiber length not shorter than 0.4 mm and not longer than 7.0 mm and have such an orientation property that orientations thereof are aligned in the foot length direction. Therefore, flexural rigidity of the reinforcement portion in the foot length direction is higher than flexural rigidity of the reinforcement portion in the foot width direction. In other words, flexural rigidity of the reinforcement portion in the foot width direction is lower than flexural rigidity of the reinforcement portion in the foot length direction. Therefore, in natural running motions in which the foot contacts the ground from the outer side in the foot width direction, loads imposed on the foot portion at the time of contact with the ground are mitigated. Since flexural rigidity of the reinforcement portion in the foot length direction is high, excessive deformation of the sole in particular at the time of take-off is suppressed and hence stability in the foot length direction is improved.

A plate according to another aspect of the embodiment is a plate used for a sole that forms a part of a shoe. The plate includes a reinforcement portion composed of a composite material containing a synthetic resin and a plurality of fibers. Flexural rigidity of the reinforcement portion in the foot length direction of the shoe is at least two times as high as flexural rigidity of the reinforcement portion in the foot width direction of the shoe. The plurality of fibers in the reinforcement portion each have a weight average fiber length not shorter than 0.4 mm and not longer than 7.0 mm.

This plate also achieves the effect similar to the above.

Preferably, the reinforcement portion has a specific gravity not larger than 1.15 and flexural rigidity of the reinforcement portion in the foot length direction of the shoe is not lower than 10 GPa and not higher than 17 GPa.

The plate may include a front reinforcement region that extends from a front end portion located at a front end in the foot length direction of the shoe to a part superimposed in a direction of thickness of the sole, on a line that connects central portions of metatarsal bones of a wearer of the shoe to each other, and the reinforcement portion may be provided over the entirety of the front reinforcement region.

In this aspect, since the reinforcement portion is arranged in a range that extends across the MP joint of the foot of the wearer in the foot length direction, excessive deformation of the sole in particular at the time of take-off is suppressed.

The plate may include a rear reinforcement region that extends from a rear end portion located at a rear end in the foot length direction of the shoe to a part superimposed in a direction of thickness of the sole, on a line that connects central portions of metatarsal bones of a wearer of the shoe to each other, and the reinforcement portion may be provided over the entirety of the rear reinforcement region.

In this aspect, since the reinforcement portion is arranged in a range that extends across the Lisfranc joint of the foot of the wearer in the foot length direction, excessive deformation of the sole in particular at the time of take-off is suppressed.

The front reinforcement region may include an inner foot region formed on an inner side in the foot width direction of the shoe, an outer foot region formed on an outer side in the foot width direction, and a middle region formed between the inner foot region and the outer foot region.

In this case, the plate may further include an outer foot support portion provided in the outer foot region. The reinforcement portion may include a middle reinforcement portion provided in the middle region, and flexural rigidity of the outer foot support portion in the foot width direction may be lower than flexural rigidity of the middle reinforcement portion in the foot width direction.

The plate may further include an inner foot support portion provided in the inner foot region. In this case, flexural rigidity of the inner foot support portion in the foot width direction is preferably lower than flexural rigidity of the middle reinforcement portion in the foot width direction.

The plate may further include a middle support portion provided in the middle region. The reinforcement portion may include an outer foot reinforcement portion provided in the outer foot region, and flexural rigidity of the outer foot reinforcement portion in the foot width direction may be lower than flexural rigidity of the middle support portion in the foot width direction.

The reinforcement portion may further include an inner foot reinforcement portion provided in the inner foot region. In this case, flexural rigidity of the inner foot reinforcement portion in the foot width direction is preferably lower than flexural rigidity of the middle support portion in the foot width direction.

A sole according to one aspect of the embodiment includes the plate and a midsole that holds the plate.

A shoe according to one aspect of the embodiment includes the sole and an upper connected to the sole and located above the sole.

A method of manufacturing a plate according to one aspect of the embodiment is a method of manufacturing a plate used for a sole that forms a part of a shoe. The method includes a preparation step of preparing a mold provided with a space in a shape conforming to the plate and an injection step of forming, by injecting a composite material containing a synthetic resin and a plurality of fibers from a toe side toward a heel side in the mold or from the heel side toward the toe side in the mold, a reinforcement portion having such an orientation property that orientations of the plurality of fibers are aligned in a foot length direction.

With this method of manufacturing a plate, in the injection step, the reinforcement portion having such an orientation property that orientations of the plurality of fibers are aligned in the foot length direction is formed. In other words, a plate that can achieve both of mitigation of shock at the time of contact with the ground and improvement in stability in the foot length direction is manufactured.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. A plate used for a sole that forms a part of a shoe, the plate comprising:
a reinforcement portion including a composite material containing a synthetic resin and a plurality of fibers, wherein
the plurality of fibers in the reinforcement portion each have a weight average fiber length from 0.4 mm to 7.0 mm and have such an orientation property that orientations are aligned in a foot length direction.

2. A plate used for a sole that forms a part of a shoe, the plate comprising:
a reinforcement portion including a composite material containing a synthetic resin and a plurality of fibers, wherein
flexural rigidity of the reinforcement portion in a foot length direction of the shoe is at least two times as high as flexural rigidity of the reinforcement portion in a foot width direction of the shoe, and
the plurality of fibers in the reinforcement portion each have a weight average fiber length from 0.4 mm to 7.0 mm.

3. The plate according to claim 1, wherein
the reinforcement portion has a specific gravity not larger than 1.15, and
flexural rigidity of the reinforcement portion in the foot length direction of the shoe is from 10 GPa to 17 GPa.

4. The plate according to claim 1, further comprising:
a front reinforcement region that extends from a front end portion located at a front end in the foot length direction of the shoe to a part superimposed in a direction of thickness of the sole, on a line that connects central portions of metatarsal bones of a wearer of the shoe to each other, wherein
the reinforcement portion is over an entirety of the front reinforcement region.

5. The plate according to claim 1, further comprising:
a rear reinforcement region that extends from a rear end portion located at a rear end in the foot length direction of the shoe to a part superimposed in a direction of thickness of the sole, on a line that connects central portions of metatarsal bones of a wearer of the shoe to each other, wherein
the reinforcement portion is over an entirety of the rear reinforcement region.

6. The plate according to claim 1, further comprising:
a front reinforcement region that extends from a front end portion located at a front end in the foot length direction of the shoe to a part superimposed in a direction of thickness of the sole, on a line that connects central portions of metatarsal bones of a wearer of the shoe to each other, wherein
the front reinforcement region includes
an inner foot region on an inner side in a foot width direction of the shoe,
an outer foot region on an outer side in the foot width direction, and
a middle region between the inner foot region and the outer foot region.

7. The plate according to claim 6, further comprising:
an outer foot support portion in the outer foot region, wherein
the reinforcement portion includes a middle reinforcement portion in the middle region, and
flexural rigidity of the outer foot support portion in the foot width direction is lower than flexural rigidity of the middle reinforcement portion in the foot width direction.

8. The plate according to claim 7, further comprising:
an inner foot support portion in the inner foot region, wherein
flexural rigidity of the inner foot support portion in the foot width direction is lower than flexural rigidity of the middle reinforcement portion in the foot width direction.

9. The plate according to claim 6, further comprising:
a middle support portion in the middle region, wherein
the reinforcement portion includes an outer foot reinforcement portion in the outer foot region, and
flexural rigidity of the outer foot reinforcement portion in the foot width direction is lower than flexural rigidity of the middle support portion in the foot width direction.

10. The plate according to claim 9, wherein
the reinforcement portion further includes an inner foot reinforcement portion in the inner foot region, and
flexural rigidity of the inner foot reinforcement portion in the foot width direction is lower than flexural rigidity of the middle support portion in the foot width direction.

11. A sole comprising:
the plate according to claim 1; and
a midsole that holds the plate.

12. A shoe comprising:
the sole according to claim 11; and
an upper connected to the sole and located above the sole.

13. A method of manufacturing a plate used for a sole that forms a part of a shoe, the method comprising:
preparing a mold having a space in a shape conforming to the plate; and
forming, by injecting a composite material containing a synthetic resin and a plurality of fibers from a toe side toward a heel side in the mold or from the heel side toward the toe side in the mold, a reinforcement portion having such an orientation property that orientations of the plurality of fibers are aligned in a foot length direction.
